(19) United States
(12) Patent Application Publication
(10) Pub. No.: US 2008/0030575 A1
(43) Pub. Date: Feb. 7, 2008

(54) SYSTEM AND METHOD INCLUDING AUGMENTABLE IMAGERY FEATURE TO PROVIDE REMOTE SUPPORT

(76) Inventors: Paul R. Davies, Huntington Beach, CA (US); Anthony E. Majoros, Cypress, CA (US)

Correspondence Address: MOORE AND VAN ALLEN PLLC FOR BOEING, 430 DAVIS DRIVE, SUITE 500, MORRISVILLE, NC, 27560, US

(21) Appl. No.: 11/462,073

(22) Filed: Aug. 3, 2006

(51) Int. Cl. H04N 7/18

(52) U.S. Cl. 348/92

(57) ABSTRACT

A system to provide remote support may include a video camera to acquire a video image of a chosen scene and a field augmenting device to present the video image. The system may also include a module associated with the field augmenting device to permit augmentation of the video image by field personnel, wherein augmentation comprises at least one of selection of a feature in the video image and association of any attributes to the selected feature. A support site augmenting device may be provided to receive a video transmission including the video image and any augmentation by the field personnel over a network from the field augmenting device and to present the video image including any augmentation to support personnel. The system may further include another module associated with the support site augmenting device to permit augmentation by the support personnel and to send the video image including any augmentation by the field personnel and any augmentation by the support personnel to the field augmenting device over the network.

### BACKGROUND OF THE INVENTION

The present invention relates to providing technical support or the like at remote locations and more particularly to system and method including an augmentable imagery feature that may be used to provide remote support.

As the complexity of modern systems increases, there is a growing need to provide effective performance support for personnel who work on and maintain these systems. These personnel are often working in remote or isolated locations and may have limited technical knowledge and resources available. Previous attempts to provide technical information and support to field personnel from a remote source or support site suffered from an inability of both field personnel and support personnel to share in the call out of, and attention to, specific features of a viewed scene. These methods cannot easily achieve the situation where each party can direct the attention of the other to precise, exact features of the viewed scene.

### BRIEF SUMMARY OF THE INVENTION

In accordance with an embodiment of the present invention, a system to provide remote support may include a video camera to acquire a video image of a chosen scene and a field augmenting device to present the video image. The system may also include a module associated with the field augmenting device to permit augmentation of the video image by field personnel, wherein augmentation comprises at least one of selection of a feature in the video image and association of any attributes to the selected feature. A support site augmenting device may be provided to receive a video transmission including the video image and any augmentation by the field personnel over a network from the field augmenting device and to present the video image including any augmentation to support personnel. The system may further include another module associated with the support site augmenting device to permit augmentation by the support personnel and to send the video image including any augmentation by the field personnel and any augmentation by the support personnel to the field augmenting device over the network.

In accordance with another embodiment of the present invention, a field augmentation device to provide remote support may include a portable computing device adapted to receive a video image of a chosen scene. The field augmentation device may also include a module operable on the portable computing device to permit augmentation of the video image by field personnel. Augmentation may include at least one of selection of a feature in the video image and association of any attributes to the selected feature. A live window or portion of a display may present the video image of the chosen scene. The field augmentation device may further include means to send a video transmission including the video image to a remote support site over a network.

In accordance with another embodiment of the present invention, a support site augmenting device may include a computing device to receive a video transmission including at least a video image of a chosen scene from a field augmenting device. A module may be operable on the computing device to permit augmentation by support personnel and to send the video image including any augmentation of the video image to the field augmenting device over a network. The support augmentation device may further include a field window or portion of a display to present the video image including any augmentation.

In accordance with another embodiment of the present invention, a method to provide remote support may include acquiring a video image of a chosen scene and presenting the video image. The method may also include permitting augmentation of the video image and presenting the video image including any augmentation by field personnel and any augmentation by support personnel.

In accordance with another embodiment of the present invention, a computer program product to provide remote support may include a computer usable medium having computer usable program code embodied therewith. The computer usable medium may include computer usable program code configured to present a video image of a chosen scene. The computer usable medium may also include computer usable program code configured to permit augmentation of the video image; and computer usable program code configured to present the video image including any augmentation by field personnel and any augmentation by support personnel.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is an illustration of an exemplary system including an augmentable imagery feature to provide remote technical support or the like in accordance with an embodiment of the present invention.

FIG. 2 is a block diagram of an example of a field augmenting device in accordance with an embodiment of the present invention.

FIGS. 3A, 3B and 2C (collectively FIG. 3) are a flow chart of an example of a method including an augmentable imagery feature to provide remote technical support or the like in accordance with an embodiment of the present invention.

FIG. 4 is an exemplary timing diagram for a method and system including an augmentable imagery feature for remote technical support or the like in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, portions of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

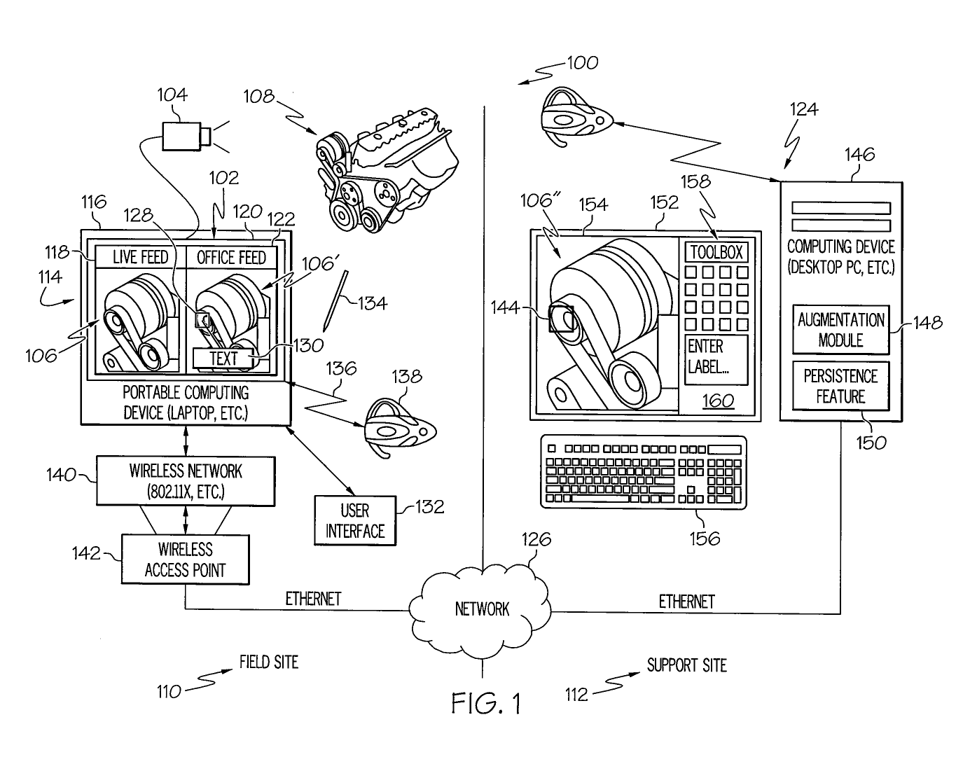

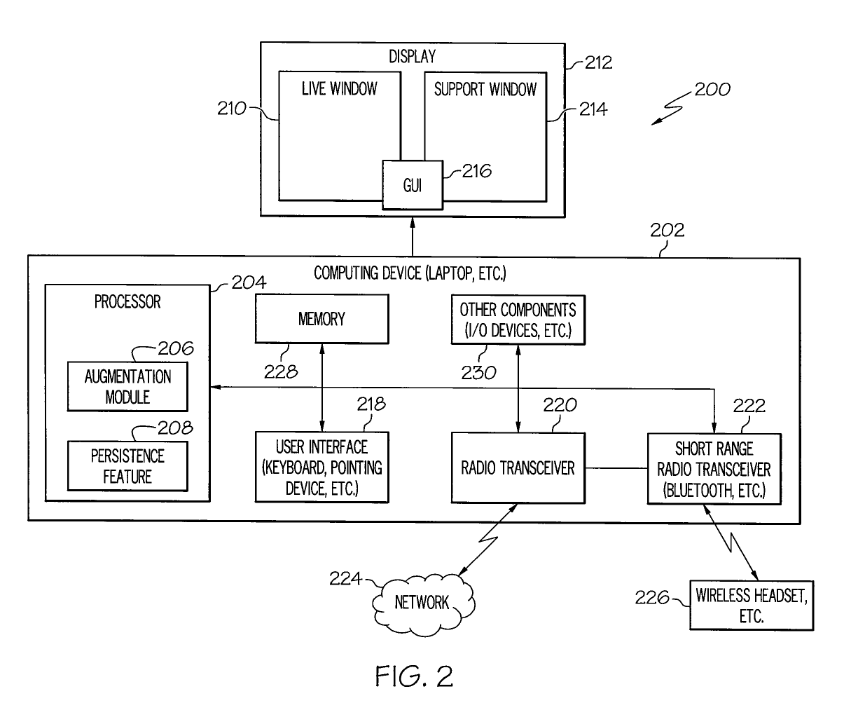

FIG. 1 is an illustration of an exemplary system 100 including an augmentable imagery feature 102 to provide remote technical support or the like in accordance with an embodiment of the present invention. The system 100 may include a video camera 104 or the like to acquire a video image 106 of a chosen scene 108. The chosen scene 108 may be a predetermined kind of equipment or machinery or an associated component, such as an aircraft or a particular component of an aircraft, an engine, or some other subject of interest that field personnel may be maintaining, repairing or working on for some reason at a field site 110 and may need technical assistance or support from a support site 112 at a remote location. The system 100 may include a field augmenting device 114 to present the video image 106 and to permit augmentation of the video image 106 by field personnel as described in more detail herein. The augmenting device 114 may be connected to the camera 104 and receive video signals from the camera 104 via a universal serial bus (USB) connection. An example of a field augmenting device that may be used for field augmenting device 114 will be described in more detail with reference to FIG. 2. The field augmenting device 114 may include a portable computing device 116, such as a tablet personal computer (PC), laptop or similar portable computing device.

The field augmenting device 114 may include a live window 118 or a “live feed” or portion of a display 120 to present the live or real-time video image 106 of the chosen scene 108. The field augmenting device 114 may also include a support window 122, “office feed” or support portion of the display 120 to present the video image 106′ including any augmentation by the field personnel returned from the support site 112 and may also include any augmentation by the support personnel sent by a support site augmentation device 124 over a network 126.

Augmentation may include at least one of selection of a feature 128 in the video image 106 and association of any attributes 130 to the selected feature 128. Attributes 130 may include but are not necessarily limited to any annotations including text, graphics or the like, highlighting, identifying or otherwise drawing attention to a particular artifact, component or subject of interest in the video image 106. Association may involve assigning, attaching or coupling in some fashion the attribute 130 to the selected component or artifact in the video image 106. As illustrated in the example of FIG. 1, the feature 128 may be selected by enclosing the feature 128 in a box type attribute that may have a brightly colored perimeter to draw attention to the feature 128. The exemplary attribute 130 in FIG. 1 further includes a text block attached to the box enclosing the feature 128. The text block may have a bright colored background to draw attention to the annotation. Other types and formats of attributes may be used by the system 100 of the present invention.

The field augmenting device 114 may include a user interface 132 and/or a touch-screen pen 134 or similar device to permit augmentation of the video image 106 similar to that just described. The touch-screen pen or similar device may be used to contact the display 120 to select features and associate any attributes to the selected features. In at least one embodiment of the present invention, a graphical user interface (GUI) or the like may be presented on the display 120 to facilitate augmenting the video image 106 as described above.

The field augmenting device 114 may also include a wired or wireless link 136 to a headset 138 or the like for voice or audio communication between a field person and support person. If a wireless link, the headset may be a wireless Bluetooth type headset or the like. In another embodiment of the present invention, a microphone and speaker may be built into the augmenting device 114 to permit audio and voice communications over the network 126 between the field site 110 and the support site 112. The system 100 may use Voice over Internet Protocol (VoIP) or similar technology for either these embodiments.

The field augmenting device 114 may access the network 126 via a wired connection or as illustrated in the exemplary embodiment of FIG. 1 via a wireless network 140. The wireless network 140 may be a wireless local area network (WLAN) or similar network for accessing a wireless access point 142. The network 126 may the Internet, intranet, extranet or other private network or limited or secure access network.

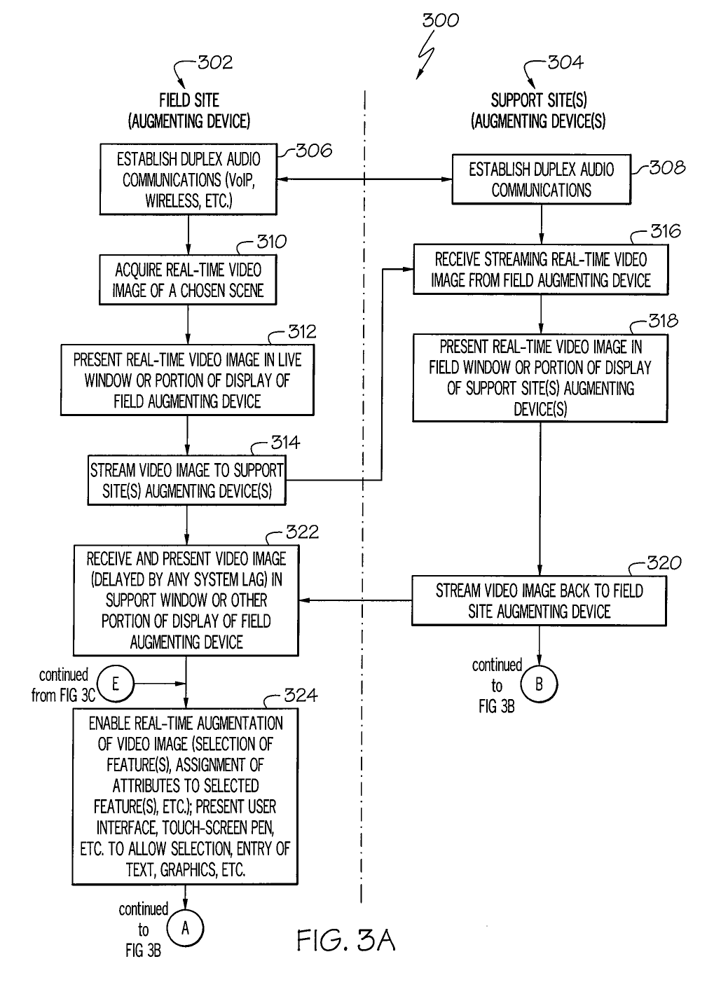

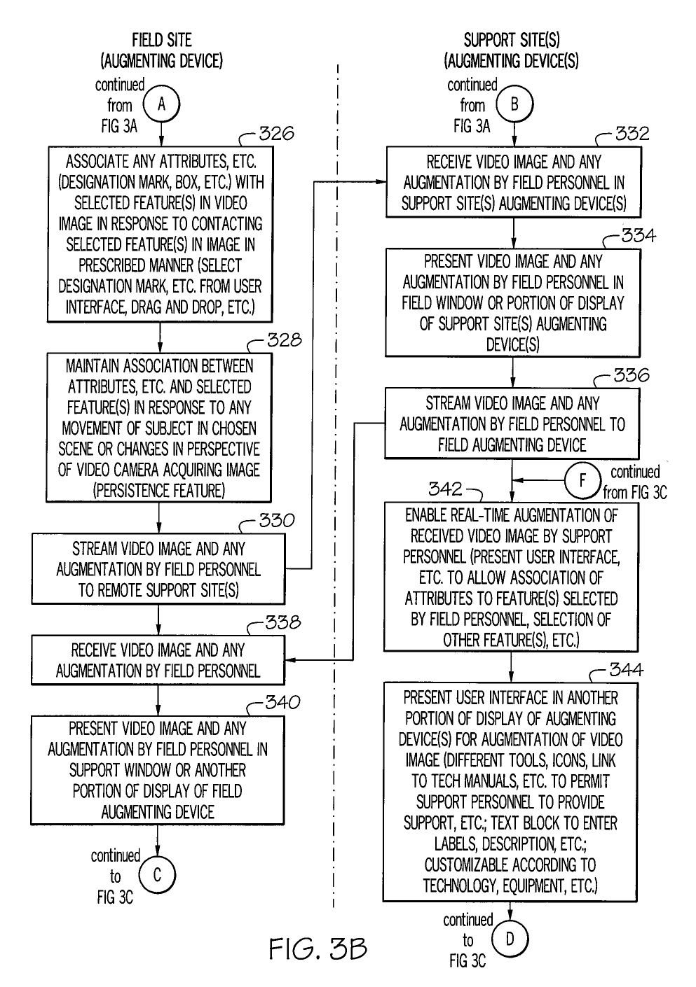

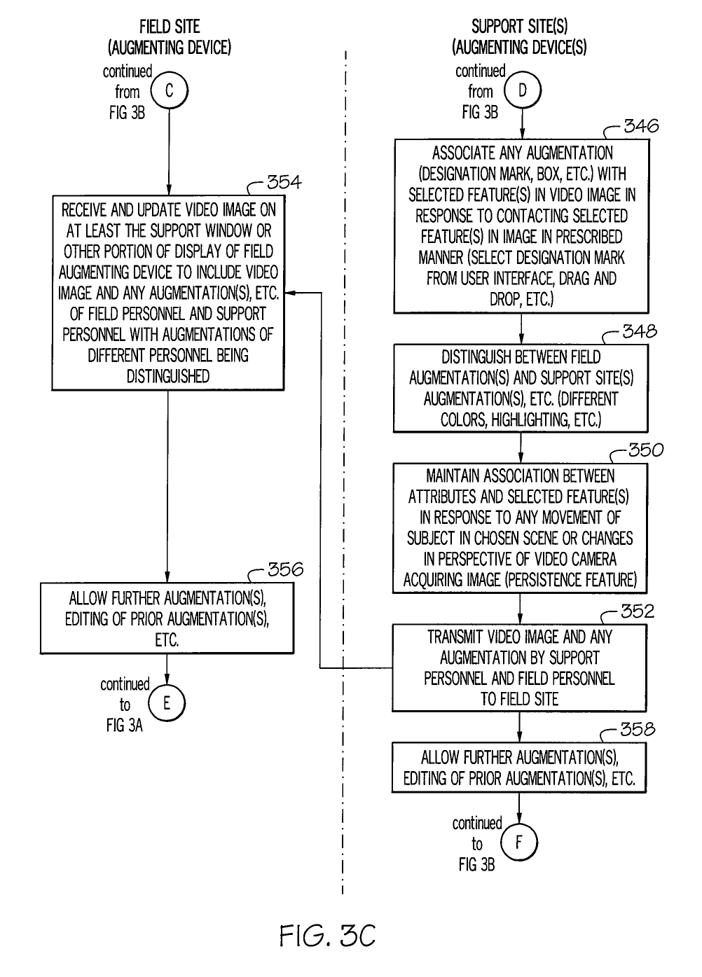

As previously described, the system 100 may include a support site augmenting device 124 to receive video transmissions over the network 126 from the field augmenting device 114. The video transmissions may include the video image 106″ and any augmentation 144 by the field personnel. The support site augmenting device 124 may include a computing device 146. The computing device 146 may be a desktop PC or similar computer device. An augmentation module 148 may be operable on the computing device 144 to permit augmentation by the support personnel. The augmentation module may also permit sending the video image including any augmentation by the field personnel and any augmentation by the support personnel to the field augmenting device 114 over the network 126. An example of a method that may be embodied in the augmentation module 148 will be described with reference to FIG. 3.

The support site augmenting device 124 may include a persistence feature 150 to maintain association between the selected feature 128 in the video image 106″ and its associated attribute 130 in response to any movement of the selected feature 128 in the chosen scene 108 or change in perspective of the video camera 104 relative to the chosen scene 108. The persistence feature 150 or some elements of the persistence feature 150 may actually be included in the field augmenting device 114 as will be described in more detail with reference to FIGS. 2 and 3.

The support augmenting device 124 may include a display 152. A field window 154 may be presented in a portion of the display 152 to present the video image 106″ including any augmentation by the field personnel and by the support personnel.

The support augmenting device 124 may further include a user interface 156 to facilitate augmentation of the video image 106″ by the support personnel. The user interface 156 may include a keyboard, a pointing device, such as a mouse or the like, and other apparatus to facilitate augmentation. A graphical user interface 158 or virtual toolbox may be presented in another portion 160 of the display 152 relative to the field window 154 to facilitate augmentation of the video image 106″ by the support personnel. The graphical user interface (GUI) 158 may include features to provide technical support associated with a predetermined kind of equipment or technology, such as a particular type of aircraft. The GU 158 may include icons or highlighting artifacts that can be dragged and dropped by a computer pointing device to select features in the video image 106″ and to assign or associate attributes to a selected feature. The GUI 158 may include links to technical manuals or the like that may be referenced by support personnel in assisting field personnel on a particular kind of equipment. Augmentation by support personnel may include but is not necessarily limited to association of other attributes with the feature or features selected by the field personnel, selection of another feature or features in the video image 106″, and association of any attributes with the other feature or features.

FIG. 2 is a block diagram of an example of a field augmenting device 200 in accordance with an embodiment of the present invention. The field augmenting device 200 may be used for the field augmenting device 114 in FIG. 1. The field augmenting device 200 may include a portable computing device 202 adapted to receive the video image 106 (FIG. 1) of the chosen scene 108. The portable computing device 202 may be a tablet personal computer (PC), laptop computer or the like. The portable computing device 202 may include processor 204. An augmentation module 206 may be operable on the processor 204 to permit augmentation of the video image 106 by the field personnel similar to that previously deacribed. An example of a method including an augmentable imagery feature for augmenting a video image that may be embodied in the augmentation module 206 will be described in more detail with reference to FIG. 3 below. A persistence feature 208 may also be operable on the processor 208. The persistence feature 208 may maintain association between the selected feature in the video image and its associated attribute or attributes in response to any movement of the selected feature in the chosen scene or change in perspective of the video camera, such as camera 104 in FIG. 1, relative to the chosen scene, such as scene 108.

The field augmenting device 200 may include a live window 210 to present the video image of the chosen scene. The live window 210 may be presented in a portion of a display 212. The live window may correspond to the live window 118 or live feed in FIG. 1 to present the real-time video image 106.

The field augmenting device 200 may also include a support window 214 to present a video image including any augmentation by field personnel and any augmentation by support personnel received from a remote support site, such as support site 112 (FIG. 1) over a network. The support window 214 may correspond to support window or office feed window 122 in FIG. 1. The support window 214 may be presented in another portion of the display 212. In another embodiment of the present invention, the live window 210 and the support window 214 may be presented in separate displays. This may permit more detailed and easier viewing of the chosen scene and selected features and assigned attributes.

A graphical user interface (GUI) 216 may be presented in the display to facilitate augmenting the video image. The GUI 216 may be similar to GUI 158 described above with reference to FIG. 1.

The augmenting device 200 may also include a user interface 218 to facilitate augmenting the video image and for controlling operation of the computing device 202. The user interface 218 may include a keyboard, pointing device or the like.

The augmenting device 200 may also include a radio transceiver 220 and a short range radio transceiver 222. The radio transceiver 220 may permit wireless or radio access to a network 224, such as a WLAN or the like. The short range radio transceiver 222 may permit communications with a wireless headset or similar device, such as headset 138 in FIG. 1, for voice communications.

The computing device 202 may include a memory 228 and other components 230, such as input devices, output device or combination input/output devices. The memory may store data, such as data related to the video images, selected features and attributes and other data for later analysis. The other components may include disk drives for inputting and outputting data, reprogramming the field augmenting device 200 or for other purposes.

FIGS. 3A, 3B and 3C (collectively FIG. 3) are a flow chart of an example of a method 300 including an augmentable imagery feature to provide remote technical support or the like in accordance with an embodiment of the present invention. The flow chart in FIG. 3 is divided to illustrate operations or functions 302 that may be performed at a field site by a field augmenting device, such as device 114 in FIG. 1, and operations or functions 304 that may be performed at a support site by a support site augmenting device, such as device 124 in FIG. 1. Accordingly, the operations 302 may be embodied in the field augmenting device 114 (FIG. 1) or 200 (FIG. 2), and the operations 304 may be embodied in the support site augmenting device 124 (FIG. 1).

In blocks 306 and 308, duplex or two-way audio or voice communications may be established between the field site and the support site. The audio communications may be any means of audio communications, such as voice over internet protocol (VoIP), wireless, such as cellular, land line, a combination of these technologies, or other means. The audio communications may also be part of or included in the video signal or data stream.

In block 310, a real-time or live video image of a chosen scene may be acquired. A video camera or similar device may be used to acquire the video image as illustrated in the exemplary system 100 of FIG. 1. As previously discussed, the chosen scene may be a particular subject of interest, such as a piece of equipment or machinery, or a specific component of the equipment, machinery or other subject of interest for repair, maintenance or other purpose.

In block 312, the real-time video image may be presented in a “live window” or portion of a display of the field augmenting device. In block 314, the video image may be streamed to the support site augmenting device. The video image may also be streamed to other support sites and augmenting devices, if there are multiple sites collaborating for whatever reason, such as training, additional technical support or specific expertise, or for other reasons.

In block 316, the support augmenting device may receive the streaming real-time video image from the field augmenting device. In block 318, the real-time video image may be presented in a “field window” or portion of a display of the support site augmenting device. In block 320, the video image may be streamed back to the field site augmenting device.

In block 322, the video image may be received and presented in a “support window,” office feed, or portion of the display of the field augmenting device similar to that illustrated in the display 120 of the field augmenting device 114 in FIG. 1. Reception and presentation of the video image from the support augmenting device may be delayed by any time lag in the system or network. In block 324, real-time augmentation of the video image may be enabled. As previously described, augmentation may involve but is not necessarily limited to selection of a feature or features in the video image, assignment or association of attributes to the selected feature or features or the like. The selected feature may be a particular part or component of interest in the video image on which it is desired to focus or draw attention of the field or support personnel. Attributes are highlights, annotations, graphics or the like to further draw attention or convey information. A user interface, such as a keyboard, pointing device, on-screen GUI or the like, may be presented to facilitate augmentation. A touch-pen or similar device may also be used to facilitate or enable augmentation of the video image.

In block 326, any attributes may be associated with the selected feature or features in the video image. Associating an attribute with the selected feature may include assigning, coupling or attaching in some way the attribute to the particular feature or artifact in the video image. This may also be considered part of the augmentation process. Associating the attribute to the selected feature may involve contacting the selected feature in a prescribed manner in the video image using a computer pointing device, touch-screen pen, dragging and dropping an icon or symbol from a menu or GUI or other means which are commonly known in manipulating items on a computer.

In block 328, a persistence feature or function may be operational. As previously described, the persistence feature provides for association between the attribute and selected feature in the video image to be maintained in response to any movement of the subject or artifact in the chosen scene or changes in perspective of the video camera acquiring the image.

In block 330, the video image and any augmentation by the field personnel may be streamed back to the support site augmenting device. In block 332, the video image and any augmentation may be received by the support site augmenting device. In block 334, the video image and any augmentation by the field personnel may be presented in the field window or portion of the display of the support site augmenting device. In block 336, the video image and any augmentation by field personnel may be streamed back to the field augmenting device.

In block 338, the video image and any augmentation by the field personnel may be received by the field augmenting device. In block 340, the video image and any augmentation by the field personnel may be presented in a “support window,” or office feed portion of the display of the field augmenting device.

In block 342, real-time augmentation by the support personnel of the video image received in block 332 may be enabled in block 342. Augmentation by the support personnel may include but is not necessarily limited to association of attributes to features selected by field personnel, selection of other features in the video image and association of attributes to those features.

In block 344, a user interface may be used to facilitate augmentation. A GUI or virtual toolbox may be presented in another portion of the display of the support site augmenting device relative to the field window or portion of the display. The GUI may include different tools, icons, links to technical manual or other features to permit support personnel to provide support or other assistance. The GUI may include icons to generate text blocks to enter labels, descriptions, instructions or similar textual information or graphics. An example of a GUI or toolbox is illustrated in FIG. 1 as GUI 158. As previously discussed, the GUI or toolbox may be customized according to a particular technology, equipment or the like. For example, in the aircraft industry, the toolbox may be for a specific type of aircraft and its various components.

In block 346, any augmentations may be associated with the selected feature in the video image. Similar to that previously discussed, the association may involve attaching, coupling, assigning or otherwise associating the augmentation with the particular feature of interest in the video image. The association may be made by contacting or touching the selected feature in the video image in a prescribed manner similar to that previously discussed.

In block 348, augmentations by the field personnel may be distinguished from augmentations by the support personnel. Examples of differentiating the augmentations may include different colors, highlighting, different fonts, text blocks with different color background, etc.

In block 350, the support site augmenting device may also include a persistence feature or function to maintain association between assigned attributes and selected features in the event of any movement of the feature or subject of interest in the chosen scene or change in perspective of the camera acquiring the video image.

In block 352, the video image and any augmentations by support personnel and field personnel may be transmitted or streamed to the field site augmenting device. In block 354, the video image including any augmentations may be received by the field augmenting device. The video image on at least the support window or portion of the display may be updated to include the video image and any augmentations by the support personnel and the field personnel. The augmentations of the different personnel may be distinguished similar to that previously discussed.

In block 356, further augmentation, editing prior augmentations and the like may be performed in the field augmenting device in block 356. The method 300 may then return to block 324 and the method may proceed as previously described. Similarly, in block 358, further augmentation, editing prior augmentations and the like may be performed in the support site augmenting device. The method 300 may then return to block 342 and the method may proceed similar to that previously described.

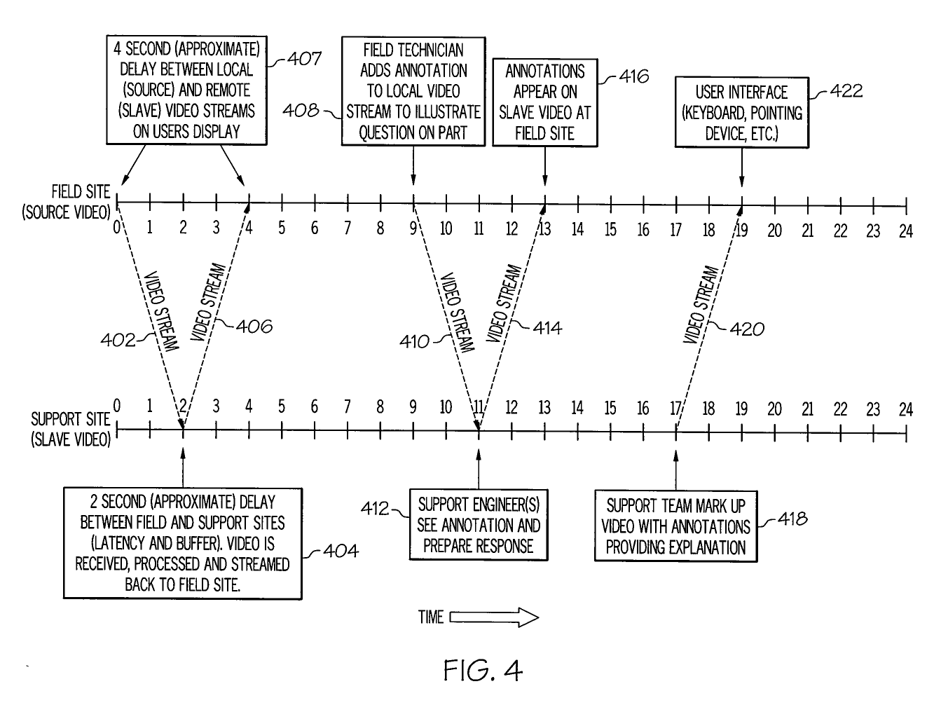

FIG. 4 is an exemplary timing diagram 400 for a method and system including an augmentable imagery feature for remote technical support or the like in accordance with an embodiment of the present invention. The timing diagram 400 may be similar to that realizable by the system 100 of FIG. 1 and the method 300 of FIG. 3. Initially, video is streamed from the field site to the support site 402. Depending upon network, system and device characteristics, such as latency, buffering or other aspects, there may be approximately a two second delay between the field site and support site. The video is received at the support site 404, processed and streamed back to the field site 406, similar to that described in method 300 (FIG. 3). Again, depending upon network, system and device characteristics, there may be about a four second delay between the local (source) or field site video and the remote (slave) or support site video streams on the respective displays or windows (live window and support or office window) of the field augmenting device (block 407).

A field technician may augment the local video stream 408. For example, annotate the video image, illustrate a question on a part, or the like. The augmented video may be streamed back to the support site 410. A support engineer may see the augmentation about two seconds later and may prepare a response 412 by further augmenting the video image similar to that described with respect to method 300 (FIG. 3). The video image augmented by the support engineer may be streamed back to the field site 414. The augmentations (annotations) may appear on the slave or support window at the field site 416 about two seconds after being streamed from the support site depending upon system, network and device characteristics.

The support team may further mark up or further augment the video in block 418 and the augmented video may be streamed to the field site 420. In block 422, the field technician sees the annotation provided by the support team approximately two seconds after being streamed from the support site.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system to provide remote support, comprising:
a video camera to acquire a video image of a chosen scene;
a field augmenting device to present the video image;
a module associated with the field augmenting device to permit augmentation of the video image by field personnel, wherein augmentation comprises at least one of selection of a feature in the video image and association of any attributes to the selected feature;
a support site augmenting device to receive a video transmission including the video image and any augmentation by the field personnel over a network from the field augmenting device and to present the video image including any augmentation to support personnel; and
another module associated with the support site augmenting device to permit augmentation by the support personnel and to send the video image including any augmentation by the field personnel and any augmentation by the support personnel to the field augmenting device over the network.

2. The system of claim 1, wherein the field augmenting device comprises a user interface to facilitate selection of the feature and association of any attributes to the selected feature.

3. The system of claim 1, further comprising a touch-screen pen for contacting a display associated with the field augmenting device to select the feature and associate any attributes to the selected feature.

4. The system of claim 1, wherein the field augmenting device comprises:
a portable computing device on which the module to permit augmentation is operable; and
a radio transceiver associated with the portable computing device to access the network.

5. The system of claim 4, wherein the field augmenting device comprises a shorter range radio transceiver for voice communications with the field personnel.

6. The system of claim 1, wherein the field augmenting device comprises:
a live window or a live portion of a display to present the video image of the chosen scene; and
a support window or a support portion of the display to present the video image including any augmentation by the field personnel and any augmentation by the support personnel sent by the support site augmentation device over the network.

7. The system of claim 6, wherein the field augmenting device comprises:
a first display to present the live window; and
a second display to present the support window.

8. The system of claim 1, further comprising a persistence feature to maintain association between the selected feature in the video image and its associated attribute in response to any movement of the selected feature in the chosen scene or change in perspective of the video camera relative to the chosen scene.

9. The system of claim 1, wherein the support site augmenting device comprises a field window or portion of a display to present the video image including any augmentation by the field personnel and by the support personnel.

10. The system of claim 9, wherein the support site augmenting device comprises a user interface to facilitate augmentation of the video image by the support personnel.

11. The system of claim 10, wherein the user interface comprises a graphical user interface presentable in another portion of the display relative to the field window to facilitate augmentation of the video image by the support personnel.

12. The system of claim 11, wherein the graphical user interface comprises features to provide technical support associated with a predetermined kind of equipment or technology.

13. The system of claim 12, wherein the predetermined kind of equipment comprises an aircraft and associated components.

14. The system of claim 1, wherein the support site augmenting device comprises a computing device on which the module to permit augmentation by the support personnel is operable.

15. The system of claim 1, wherein augmentation by the support personnel comprises at least one of association of any other attributes with the feature selected by the field personnel, selection of another feature in the video image, and association of any attributes with the other feature.

16. The system of claim 1, wherein the support site augmenting device comprises a short range radio transceiver for voice communications with the support personnel.

17. The system of claim 1, further comprising a component to distinguish between augmentation by the field personnel and augmentation by the support personnel.

18. The system of claim 1, wherein the video transmission comprises an audio signal.

19. A field augmentation device to provide remote support, comprising:
a portable computing device adapted to receive a video image of a chosen scene;
a module operable on the portable computing device to permit augmentation of the video image by field personnel, wherein augmentation comprises at least one of selection of a feature in the video image and association of any attributes to the selected feature;
a live window or portion of a display to present the video image of the chosen scene; and
means to send a video transmission including the video image to a remote support site over a network.

20. The field augmentation device of claim 19, further comprising a support window or another portion of the display to present the video image including any augmentation by field personnel and any augmentation by support personnel received from the remote support site over the network.

21. The field augmentation device of claim 19, further comprising a user interface to facilitate selection of the feature and association of any attributes to the selected feature.

22. The field augmentation device of claim 19, further comprising:
a radio transceiver to access the network; and
a shorter range transceiver for voice communications with the field personnel.

23. The field augmentation device of claim 19, further comprising a persistence feature to maintain association between the selected feature in the video image and its associated attribute in response to any movement of the selected feature in the chosen scene or change in perspective of the video camera relative to the chosen scene.

24. A support site augmenting device, comprising:
a computing device to receive a video transmission including at least a video image of a chosen scene from a field augmenting device;
a module operable on the computing device to permit augmentation by support personnel and to send the video image including any augmentation of the video image by the field personnel and any augmentation of the video image by the support personnel to the field augmenting device over a network, wherein augmentation comprises at least one of selection of a feature in the video image and association of any attributes to the selected feature; and
a field window or portion of a display to present the video image including any augmentation.

25. The support site augmenting device of claim 24, further comprising a graphical user interface presentable in another portion of the display relative to the field window to facilitate augmentation of the video image by the support personnel.

26. The support site augmenting device of claim 25, wherein the graphical user interface comprises features to provide technical support associated with a predetermined kind of equipment or technology.

27. A method to provide remote support, comprising:
acquiring a video image of a chosen scene;
presenting the video image;
permitting augmentation of the video image; and
presenting the video image including any augmentation by field personnel and any augmentation by support personnel.

28. The method of claim 27, wherein augmentation comprises at least one of:
selecting a feature in the video image; and
associating any attributes to the selected feature.

29. The method of claim 28, wherein associating any attributes to the selected feature comprises contacting the selected feature in a predetermined manner.

30. The method of claim 28, further comprising maintaining association between any attributes and the selected feature in response to any movement of the chosen scene or changes in perspective of a video camera acquiring the video image.

31. The method of claim 27, further comprising:
presenting the video image in one portion of a display; and
presenting a graphical user interface in another portion of the display to facilitate augmentation of the video image.

32. The method of claim 31, further comprising customizing the graphical user interface to provide technical support associated with a predetermined kind of equipment or technology.

33. The method of claim 27, further comprising:
presenting the video image in real-time in a live window or portion of a display; and
presenting the video image and any augmentation in a support window or other portion of the display.

34. A system to perform the method of claim of claim 27.

35. A computer readable medium having computer-executable instructions to perform the method of claim 27.

36. A computer program product to provide remote support, the computer program product comprising:
a computer usable medium having computer usable program code embodied therewith, the computer usable medium comprising:
computer usable program code configured to present a video image of a chosen scene;
computer usable program code configured to permit augmentation of the video image; and
computer usable program code configured to present the video image including any augmentation by field personnel and any augmentation by support personnel.

37. The computer program product of claim 36, wherein the computer usable program code configured to permit augmentation of the video image, comprises:
computer usable program code configured to select a feature in the video image; and
computer usable program code configured to associate any attributes to the selected feature.

38. The computer program product of claim 37, further comprising computer usable program code configured to maintain association between any attributes and the selected feature in response to any movement of the chosen scene or changes in perspective of a video camera acquiring the video image.

39. The computer program product of claim 36, further comprising computer usable program code configured to presenting the video image in real-time in a live window or portion of a display and to present the video image and any augmentation in a support window or other portion of the display.

40. The computer program product of claim 36, further comprising computer usable program code configured to present the video image in one portion of a display and to present a graphical user interface in another portion of the display to facilitate augmentation of the video image.
